(19) United States
(12) Patent Application Publication
(10) Pub. No.: US 2026/0340377 A1
(43) Pub. Date: Oct. 29, 2026

(54) CRITICALLY SYNCHRONIZED NETWORK FOR EFFICIENT MACHINE LEARNING

(71) Applicant: THE REGENTS OF THE UNIVERSITY OF CALIFORNIA, Oakland, CA (US)

(72) Inventors: Lawrence R. FRANK, San Diego, CA (US); Vitaly L. GALINSKY, San Diego, CA (US)

(21) Appl. No.: 19/119,708

(22) PCT Filed: Oct. 10, 2023
(86) PCT No.: PCT/US2023/034850

§ 371 Date: Apr. 9, 2025

Related U.S. Application Data
(60) Provisional application No. 63/414,872, filed on Oct. 10, 2022.

(51) Int. Cl. G06N 3/08; G06N 3/04

(52) U.S. Cl. CPC G06N 3/08; G06N 3/04

(57) ABSTRACT

The shallow neural network with multiple recurrent and redundant loop-like wave mediated neuronal connections employs amplitude weighting factors and a phase parameter represented by non-planar connection paths. The presence of non-planarity in the connection paths allows faster and more efficient computations, reduced memory demands, and enhanced learning capabilities compared to traditional multi-layer deep AI/ML neural networks.

### RELATED APPLICATIONS

This application claims the benefit of U.S. Provisional Application No. 63/414,872, filed Oct. 10, 2022, which is incorporated herein by reference in its entirety.

### FIELD OF THE INVENTION

The present invention relates to a machine learning model and more specifically to a neural network model based on physical properties of brain tissue and their support of electromagnetic wave propagation.

### BACKGROUND

The effectiveness, robustness, and flexibility of memory and learning constitute the very essence of human natural intelligence, cognition, and consciousness. Artificial intelligence and machine learning (AI/ML) methods were initially developed as attempts derive algorithms that match the efficiency and accuracy of human brain computations by constructing algorithms that structurally and functionally mimicked the brain's complex cooperative and coherent neuronal structure. However, the inadequacies in existing neuronal models, due in large part to lack of any connection with the physics of how cooperative neuronal activity relates to brain waves activity, resulted in algorithms based on the general concept of neural nets, which are essentially communicating layers of an ad-hoc hierarchical structure. More complex layers are addressed by adding more layers and ad-hoc rules for communication between the layers.

The absence of a solid theoretical framework has implications not only for our understanding of how the brain works, but also for wide range of computational models developed from the standard orthodox view of brain neuronal organization and brain network derived functioning based on the Hodgkin-Huxley ad-hoc circuit analogies that have produced a multitude of Artificial, Recurrent, Convolution, Spiking, etc., Neural Networks (ARCSe NNs) that have in turn led to the standard algorithms that form the basis of artificial intelligence (AI) and machine learning (IL) methods.

Recent advances in experimental neuroscience and neuroimaging have highlighted the importance of considering the interactions of the wide-range of spatial and temporal scales at play in brain function, from the microscales of subcellular dendrites, synapses, axons, somata, to the mesoscales of the interacting networks of neural circuitry, the macroscales of brain-wide circuits. Current theories derived from these experimental data suggest that ability of humans to learn and adapt to ever-changing external stimuli is predicated on the development of complex, adaptable, efficient, and robust circuits, networks, and architectures derived from flexible arrangements among the variety of neuronal and non-neuronal cell types in the brain. A viable theory of memory and learning must therefore be predicated on a physical model capable of producing multiscale spatiotemporal phenomena consistent with observed data.

At the heart of all current models for brain electrical activity is the neuron spiking model formulated by Hodgkin and Huxley (the “HH model) (Hodgkin, A. L. & Huxley, A. F., “A quantitative description of membrane current and its application to conduction and excitation in nerve”, J. Physiol. (Lond.) 117, 500-544 (1952)), which has provided quantitative descriptions of Na⁺/K⁺ fluxes, voltage- and time-dependent conductance changes, the waveforms of action potentials, and the conduction of action potentials along nerve fibers. Unfortunately, although the HH model has been useful in fitting multiparametric set of equations to local membrane measurements, the model has been of limited utility in deciphering complex functions arising in interconnected networks of brain neurons. From a practical standpoint, the original HH model is too complicated to describe even relatively small networks. This has resulted in the development of optimization techniques based on a reduced model of a leaky integrate-and-fire (LIF) neuron that is simple enough for use in neural networks, as it replaces the multiple gates, currents, channels and thresholds with a single threshold and time constant. A majority of spiking neural network (SNN) models use this simplistic LIF neuron for the so called “deep learning”, with assertions that this is inspired by brain functioning. While multiple LIF models are used for image classification on large datasets, most applications of SNNs are still limited to less complex datasets, due to the complex dynamics of even the oversimplified LIF model and non-differentiable operations of LIF spiking neurons. Some remarkable studies have applied SNNs for object detection tasks. Spike based methods have also been used for object tracking. LIF spiking networks have been reported for online learning, braille letter reading, different neuromorphic synaptic devices for detection and classification of a variety of biological problems. Areas of focus include making human-level control, optimizing back-propagation algorithms for spiking networks, as well as penetrating much deeper into ARCSes core with fewer time steps, using an event-driven paradigm, applying batch normalization, scatter-and-gather optimizations, supervised plasticity, time-step binary maps, and using transfer learning algorithms. In concert with this broad range of software applications, there is significant research directed at developing and using these LIF SNN in embedded applications with the help of the “neuromorphic hardware”, the generic name given to hardware that is nominally based on, or inspired by, the structure and function of the human brain. Nonetheless, while the LIF model is widely accepted and ubiquitous in neuroscience, it can be problematic in that it does not generate any spikes per se.

A single LIF neuron can be described in differential form as:

$${τ}_{m} \frac{\partial U}{\partial t} = - ( U - {U}_{rest} ) + RI , \qquad ( 1 )$$

where U(t) is the membrane potential, Uᵣₑₛₜ is the resting potential, τₘ is the membrane time constant, R is the input resistance, and I(t) is the input current. It is important to note that Equation (1) does not describe actual spiking. Rather, it integrates the input current I(t) in the presence of an input membrane voltage U(t). In the absence of the current I(t), the membrane voltage rapidly (exponentially) decays with time constant τₘ to its resting potential Uᵣₑₛₜ. In this sense, the integration is “leaky”. There is no structure in this equation that even approximates a system resonance that might be described as “spiking”. Moreover, both the decay constant τₘ and the resting potential Uᵣₑₛₜ are not only unknowns, but assumed constant, and therefore significant oversimplifications of the actual complex tissue environment.

The mismatch between the observed spiking behavior of neurons and a model system that is incapable of producing spiking was met not with a reformulation to a more physically realistic model, but instead with what can only be described as an ad-hoc patchwork fix: the introduction of a “firing threshold” Θ that defines when a neuron finally stops integrating the input, resulting in a large action potential almost magically shared with its neighboring neurons, after which the membrane voltage U is reset by hand back to the resting potential Uᵣₑₛₜ. Adding these conditions results in Equation (1) being only capable of describing the dynamics that occur when the membrane potential U is below this spiking ruler threshold Θ. It is important to recognize that this description of the “sub-threshold” dynamics of the membrane potential until it has reached its firing threshold describes a situation where neighboring neurons are not affected by what is essentially a description of sub-threshold noise.

In short, the physical situation described by Equation (1) is contradictory to many careful neuroscience experiments that show, for example, that: (a) the neuron is anisotropically activated following the origin of the arriving signals to the membrane; (b) a single neuron's spike waveform typically varies as a function of the stimulation location; (c) spatial summation is absent for extracellular stimulations from different directions; and (d) spatial summation and subtraction are not achieved when combining intra- and extra-cellular stimulations, as well as for nonlocal time interference. Such observations have led to calls “to re-examine neuronal functionalities beyond the traditional framework”.

A physics-based model of brain electrical activity has demonstrated that in the inhomogeneous anisotropic brain tissue system, the underlying dynamics is not necessarily restricted by reaction-diffusion type only. See, e.g., Galinsky, V. L. & Frank, L. R., “Universal theory of brain waves: From linear loops to nonlinear synchronized spiking and collective brain rhythms. Phys. Rev. Res. 2(023061), 1-23 (2020); Galinsky, V. L. & Frank, L. R., “Brain waves: Emergence of localized, persistent, weakly evanescent cortical loops”. J. Cogni. Neurosci. 32, 2178-2202 (2020); and Galinsky, V. L. & Frank, L. R., “Collective synchronous spiking in a brain network of coupled nonlinear oscillators”, Phys. Rev. Lett. 126, 158102 (2021), each of which is incorporated herein by reference. This theory of weakly evanescent transverse cortical waves, referred to as “WETCOW”, shows from a physical point of view that propagation of electromagnetic fields through the highly complex geometry of inhomogeneous and anisotropic domain of real brain tissues can also happen in a wave-like form. This wave-like propagation generally agrees with the above-described neuronal experiments as well explaining the broad range of observed seemingly disparate brain spatiotemporal characteristics. The theory produces a set of nonlinear equations for both the temporal and spatial evolution of brain wave modes that include all possible nonlinear interaction between propagating modes at multiple spatial and temporal scales and degrees of nonlinearity. The theory bridges the gap between the two seemingly unrelated spiking and wave ‘camps’ as the generated wave dynamics includes the complete spectra of brain activity ranging from incoherent asynchronous spatial or temporal spiking events, to coherent wave-like propagating modes in either temporal or spatial domains, to collectively synchronized spiking of multiple temporal or spatial modes.

### SUMMARY

The inventive approach provides a fast and accurate algorithm for neural network design and generation appropriate for finding unique sets of patterns in large datasets. The algorithm is applicable in the broad range of applications that currently employ Artificial Intelligence/Machine Learning (AI/ML) techniques, such as identifying written characters, classifying multiple images, and identifying properties of networks, e.g., connectivity.

The synchronized neural network according to the inventive approach is based on non-linear interactions of weakly evanescent transverse cortical waves (“WETCOW”) derived directly from the physical properties of brain tissues and their support of electromagnetic wave propagation. WETCOWs explain efficient synchronization of brain activity and hence efficient learning and memory organization though formation of multiple recurrent and redundant loop-like wave mediated neuronal connections.

The inventive WETCOW-inspired shallow neural network (“WiSNN”) model employs amplitude weighting factors and a phase parameter that is represented by non-planar connection paths. The presence of non-planarity in a single layer (shallow) amplitude-phase synchronized neural network allows more efficient computations, memory requirements, and learning capabilities than traditional multi-layer deep AI/ML neural networks. The inventive scheme takes as input the same information that any AI/ML problem would input, such as a large set of images to classify (e.g., written characters, types of clothing, plant varieties, etc.), and a set of “training” data of the same general type. The end product is the set of unique objects from the input set based on the training set.

The WETCOW-inspired neural network according to the inventive approach can nearly double the accuracy of existing AI/ML approaches, with over two orders of magnitude (~500 times) improvement in speed. The implementation is for neural network design and generation is appropriate for finding unique sets of patterns in large datasets, typically applied to identifying written characters and classifying multiple images. The inventive approach can also be extended to other networks such as cellular and radar networks, and can be applied to a wide range of applications such as communications and meteorology.

In one aspect, a neural network for machine learning includes: an input layer comprising input elements configured for inputting data for processing; an output layer comprising one or more output elements; and a plurality of wave modes connecting the input elements to the one or more output elements, each wave mode comprising a recurrent path having an amplitude, a linear frequency, and a phase parameter, wherein the phase parameter is configured to control non-planarity of each wave mode so that amplitude and phase of the plurality of wave modes are coupled and spiking of the plurality of wave modes is synchronized at a same effective spiking frequency that is within a range of a critical frequency. In some embodiments, the data for processing comprises training data having known outcomes. The amplitude and phase may be coupled according to the relationships:

$$\frac{d {A}_{i}}{dt} = {γ}_{i} {A}_{i} + {A}_{i}^{2} ( {w}_{i}^{a} cos ( {ϕ}_{i} - {ψ}_{i} ) - {α}_{i} ) + {\sum }_{j \neq i} {w}_{ij} {A}_{j} cos ( {ϕ}_{j} - {ϕ}_{i} - {δ}_{ij} )$$

and

$${A}_{i} \frac{d {ϕ}_{i}}{dt} = {ω}_{i} {A}_{i} + {A}_{i}^{2} {w}_{i}^{ϕ} cos {ϕ}_{i} + {\sum }_{j \neq i} {w}_{ij} {A}_{j} sin ( {ϕ}_{j} - {ϕ}_{i} - {δ}_{ij} ) ,$$

where Ai is the amplitude, φ is the phase, ω is the wave mode frequency, and δ is static network attributed phase delay factors. The critical frequency may be ωₑ=γω, where

$$w = \frac{{w}^{ϕ} cos {ϕ}^{c}}{α + {w}^{a} cos ( {ϕ}^{c} + ψ )} , {ϕ}^{c} = arctan [ \frac{{w}^{a} sin ψ}{\sqrt{{α}^{2} - {( {w}^{a} sin ψ )}^{2}}} ] ,$$

and γ is a growth or damping rate.

In some embodiments, the input layer is configured for receiving sensor data in a communications network. The output layer may be configured for generating output signals to an application layer in the communications network. In certain embodiments, the communications network may be an Internet of Things (IoT) network.

In another aspect, a neural network apparatus includes: a processor configured to generate a neural network including: an input layer having input elements configured for inputting data; an output layer comprising one or more output elements; and a plurality of wave modes connecting the input elements to the one or more output elements, each wave mode comprising a recurrent path having an amplitude, a linear frequency, and a phase parameter, wherein the phase parameter is configured to control a shape and planarity of each wave mode so that amplitude and phase of the plurality of wave modes are coupled and spiking of the plurality of wave modes is synchronized at a same effective spiking frequency that within a range of a critical frequency. The amplitude and phase may be coupled according to the relationships:

$$\frac{d {A}_{i}}{dt} = {γ}_{i} {A}_{i} + {A}_{i}^{2} ( {w}_{i}^{a} cos ( {ϕ}_{i} - {ψ}_{i} ) - {α}_{i} ) + {\sum }_{j \neq i} {w}_{ij} {A}_{j} cos ( {ϕ}_{j} - {ϕ}_{i} - {δ}_{ij} )$$

and

$${A}_{i} \frac{d {ϕ}_{i}}{dt} = {ω}_{i} {A}_{i} + {A}_{i}^{2} {w}_{i}^{ϕ} cos {ϕ}_{i} + {\sum }_{j \neq i} {w}_{ij} {A}_{j} sin ( {ϕ}_{j} - {ϕ}_{i} - {δ}_{ij} ) ,$$

where Ai is the amplitude, φ is the phase, ω is the wave mode frequency, and δ is static network attributed phase delay factors. The critical frequency may be ω_{c}=γω, where

$$w = \frac{{w}^{ϕ} cos {ϕ}^{c}}{α + {w}^{a} cos ( {ϕ}^{c} + ψ )} , {ϕ}^{c} = arctan [ \frac{{w}^{a} sin ψ}{\sqrt{{α}^{2} - {( {w}^{a} sin ψ )}^{2}}} ] ,$$

and γ is a growth or damping rate.

In some embodiments, the input layer is configured for receiving sensor data in a communications network. The output layer may be configured for generating output signals to an application layer in the communications network. In certain embodiments, the communications network may be an Internet of Things (IoT) network.

In still another aspect, a processor implemented learning method includes: generating within a processor a neural network by connecting input elements of an input layer to one or more output elements of an output layer using a plurality of wave, each wave mode comprising a recurrent path having an amplitude, a linear frequency, and a phase parameter, wherein amplitude and phase of the plurality of wave modes are coupled and the phase parameter is configured to control non-planarity of each wave mode; and applying input data to the input elements and adjusting the amplitude and phase parameter of each wave mode to synchronize spiking of the plurality of wave modes at a same effective spiking frequency that is within a range of a critical frequency. The amplitude and phase may be coupled according to the relationships:

$$\frac{{dA}_{i}}{dt} = {γ}_{i} {A}_{i} + {A}_{i}^{2} ( {w}_{i}^{a} cos ( {ϕ}_{i} - {ψ}_{i} ) - {α}_{i} ) + {\sum }_{j \neq i} {w}_{ij} {A}_{j} cos ( {ϕ}_{j} - {ϕ}_{i} - {δ}_{ij} )$$

and

$${A}_{i} \frac{{dϕ}_{i}}{dt} = {ω}_{i} {A}_{i} + {A}_{i}^{2} {w}_{i}^{ϕ} cos {ϕ}_{i} + {\sum }_{j \neq i} {w}_{ij} {A}_{j} sin ( {ϕ}_{j} - {ϕ}_{i} - {δ}_{ij} ) ,$$

where Ai is the amplitude, φ is the phase, ω is the wave mode frequency, and δ is static network attributed phase delay factors. The critical frequency may be ω_{c}=γω, where

$$w = \frac{{w}^{ϕ} cos {ϕ}^{c}}{α + {w}^{a} cos ( {ϕ}^{c} + ψ )} , {ϕ}^{c} = arctan [ \frac{{w}^{a} sin ψ}{\sqrt{{α}^{2} - {( {w}^{a} sin ψ )}^{2}}} ] ,$$

and γ is a growth or damping rate.

In some embodiments, the input layer is configured for receiving sensor data in a communications network. The output layer may be configured for generating output signals to an application layer in the communications network. In certain embodiments, the communications network may be an Internet of Things (IoT) network.

### BRIEF DESCRIPTION OF THE DRAWINGS

FIG. 1A is a schematic graph of typical multi-layer neural network where connection weights are shown by varying path width; FIG. 1B is a schematic graph of critically synchronized WETCOW-inspired shallow neural network (WiSNN), where amplitude weighting factors are shown by varying path widths, but an additional phase parameter controls the non-planar recurrent paths behavior.

FIG. 2A is a plot of the analytical expression (Equation (14)) for the effective spiking frequency ωₛ=2π/Tₛ (lower curve) and the frequency estimated from numerical solutions of Equations (11) and (12) with several insets showing the numerical solution with indicated value of the criticality parameter cr=γ/γc; FIGS. 2B and 2C provide examples of detailed amplitude and phase plots used to generate different numerical solutions shown in the insets of FIG. 2A.

FIGS. 3A-3F are amplitude and phase plots, respectively, of a single mode subcritical spiking (FIGS. 3A-3B); the spiking of multiple modes with different linear frequencies ωᵢ critically synchronized at the same effective spiking frequency (the units are arbitrary) (FIGS. 3C-3D); FIGS. 3E-3F provide expanded views of the initial part of the amplitude and phase of the mode showing the efficiency of synchronization.

FIGS. 4A-4F are amplitude and phase plots, respectively, of a single mode spiking in a close to critical regime (FIGS. 4A-4B); The spiking of multiple modes with different linear frequencies ωᵢ critically synchronized at the same effective spiking frequency that is close to critical frequency (the units are arbitrary) (FIGS. 4C-4D); FIGS. 4E-4F provide expanded views of the initial part of the amplitude and phase of the mode shows the efficiency of synchronization.

FIG. 5 is a flow diagram of the basic operation of a WiSNN model according to the inventive approach.

FIG. 6 is a first set of sample images from a public database (MNIST) used to test the inventive approach.

FIG. 7 is a second set of sample images from the MNIST database used to test the inventive approach.

FIG. 8 is a block diagram of an Internet of Things (IoT) architecture implemented using an embodiment of the inventive WiSNN model.

### DETAILED DESCRIPTION OF EMBODIMENTS

The inventive approach provides a fast and accurate algorithm for neural network design and generation appropriate for finding unique sets of patterns in large datasets. The algorithm is applicable in the very broad range of applications that currently employ Artificial Intelligence/Machine Learning (AI/ML) techniques, such as identifying written characters and classifying multiple images.

The approach disclosed herein is based on the recognition that memory, learning, and consciousness rely on networks of HH (LIF) neurons as biological and/or physical basis. Every single neuron in this case is assumed to be an element (or a node) with fixed properties that isotropically collects input and fires when enough has been collected. The learning algorithms are processes that update network properties, e.g., connection strength between those fixed nodes through plasticity, or number of participating fixed neuron nodes in the network through birth and recruitment of new neuron nodes, etc. The inventive approach focuses on a different aspect of network functioning and assumes that the network is formed not by fixed nodes (neurons) but by flexible pathways encompassing propagating waves, or wave packets, or wave modes. Formally those wave modes play in any network of wave modes the same role as single HH (LIF) node in network of neurons. For purposes of the present description, the phrases “wave mode” and “network node”, and the terms “mode” and “node”, may be used interchangeably. As any single neuron may encounter multiple wave modes arriving from any other neuron, and synchronization with or without spiking will manifest as something that looks like anisotropic activation depending on the origin of the arriving signals, this wave network paradigm is capable of characterizing much more complex and subtle coherent brain activity and thus shows more feature-rich possibilities for “learning” and memory formation.

The WETCOW-inspired synchronized neural network has several important properties. First, the presence of both amplitude wᵢⱼ and phase δᵢⱼ coupling makes it possible to construct effective and accurate recurrent networks that do not require extensive and time consuming training. The standard back propagation approach tends to be expensive in terms of computations, memory usage, and the large number of communications involved. As a result, they may be poorly suited to the hardware constraints in computers and neuromorphic devices. However, the WETCOW-based network is small and shallow, capable of replicating the spiking produced by an input condition using the interplay of amplitude-phase coupling and the explicit analytical conditions for spiking rate as a function of criticality, both of which are described below. The shallow neural networks (WiSNNs) constructed using these analytical conditions provide accurate results with little training and relatively small memory requirements.

The WETCOW-inspired shallow neural network (WiSNN) model relies on several different memory phenomena. From a non-mathematical perspective, WiSNN can be described as:
Critical encoding—the WETCOW model shows how independent oscillators in a heterogeneous network with different parameters form a coherent state (memory) as a result of critical synchronization.
Synchronization speed—the WETCOW model shows that due to coordinated work of amplitude-phase coupling, this synchronization process is significantly faster than memory formation in the spiking network of integrate-and-fire neurons.
Storage capacity—the WETCOW model shows that a coherent memory state with predicted encoding parameters can be formed with as low as two modes, thus potentially allows for significant increase of memory capacity comparing to the traditional spiking paradigm.
Learning efficiency—the WETCOW model shows that processing of a new information by a mean of synchronization of network parameters in a near critical range allows a natural development of continuous learner-type memory representative of human knowledge processing.
Memory robustness—the WETCOW model shows that memory state formed in non-planar critically synchronized network potentially more stable, continuous learning prone, and resilient to catastrophic forgetting.

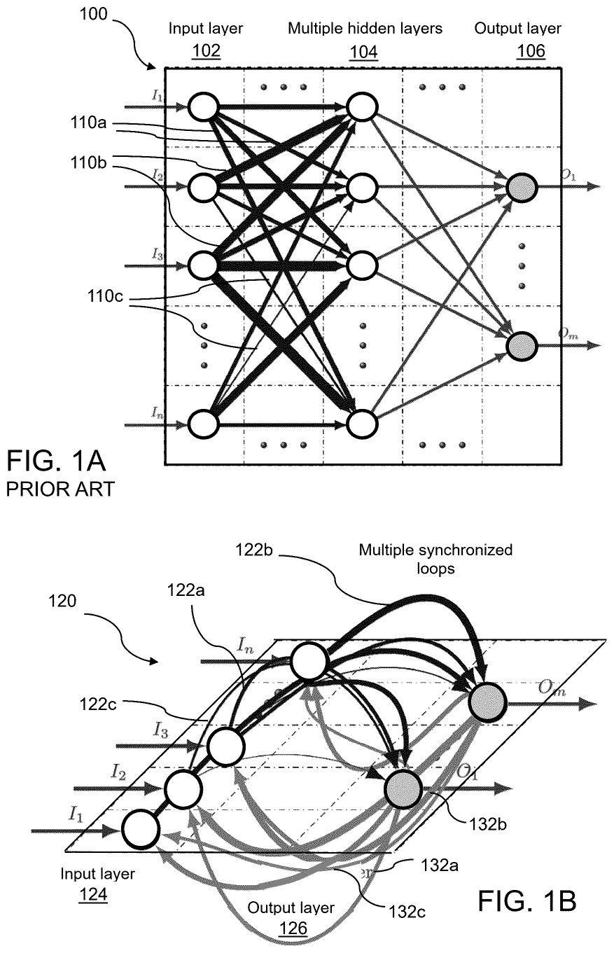

FIGS. 1A and 1B are comparative schematic diagrams for the typical workflow of traditional multi-layer ARCSe neural network 100 and the inventive critically synchronized WETCOW-inspired shallow neural network (WiSNN) 120. The traditional multi-layer ARCSe neural network 100 includes input layer 102 with multiple inputs (I₁-In), hidden layer(s) 104, and output layer 106 (O₁-Oₘ) where the connection weights are approximated by varying path widths (110a, 110b, 110c) as indicated in the figure. For example, as illustrated, paths 110b have heavier weights than paths 110a, which have heavier weights than paths 110c. In contrast, the critically synchronized WETCOW-inspired shallow neural network 120 has input layer 124 with inputs II-In, output layer 126 with outputs O₁-Oₘ, input paths 122a, 122b, 122c (with varying weights as shown), and employs amplitude weighting factors (indicated by the different recurrent path widths 132a (medium), 132b (wide), 132c (narrow)) where an additional phase parameter controls the non-planar recurrent paths' behavior. The interplay of amplitude-phase synchronization, indicated by the non-planarity of shallow neural network 120 (comprising a single layer of synchronized loops) allows more efficient computation, reduces memory demand, and increases learning capabilities compared to multi-layer deep ARCSes of traditional AI/IL neural networks.

The non-planarity of the critically synchronized WETCOW-inspired shallow neural network 102 illustrates and emphasizes another important advantage in comparison to the traditional multi-layer ARCSe neural networks 100. It is well known that the traditional multi-layer deep learning ARCSe neural network models suffer from the phenomenon of catastrophic forgetting-a deep ARCSe neural network, carefully trained and back and forth massaged to perform an important task can unexpectedly lose its generalization ability on this task after additional training on a new task has been performed. This typically happens because a new task overrides the previous weights that have been learned in the past. Thus, continued learning can degrade or even destroy the model performance for the previous tasks. This is a significant problem, making traditional deep ARCSe neural networks a poor choice to function as a continuous learner, as it can suffer from “overload”, forgetting previously learned knowledge upon being exposed to a massive amount of new information. As any new information added to the traditional multi-layer deep learning ARCSe neural network inevitably modifies the network weights confined to the same plane and shared with all previously accumulated knowledge produced by a hard training work, this catastrophic forgetting phenomena is generally not a surprise. The non-planarity of the critically synchronized WiSNN provides an additional approach to encode new knowledge with a different out-of-plane phase-amplitude choice, thus preserving previous accumulated knowledge. This makes the critically synchronized WiSNN model more suitable for use in a continuous learning scenario. Another important advantage of the WETCOW algorithms is their numerical stability, which makes them robust even in the face of extensive training.

The following discussion provides underlying principles of WETCOW as a model for efficient learning and memory organization through formation of multiple recurrent and redundant loop-like wave mediated neuronal connections.

### Weakly Evanescent Brain Waves

A set of derivations that led to the WETCOW description was presented by Galisnky and Frank (supra) and is based on considerations that follow from the most general form of brain electromagnetic activity expressed by Maxwell equations in inhomogeneous and anisotropic medium

$$∇ \cdot D = ρ , ∇ \times H = J + \frac{\partial D}{\partial t} ⟹ \frac{\partial ρ}{\partial t} + ∇ \cdot J = 0.$$

Using the electrostatic potential EE=−∇Ψ, Ohm's law J=σ·E (where σ≡{σᵢⱼ} is an anisotropic conductivity tensor), a linear electrostatic property for brain tissue D=εE, assuming that the scalar permittivity ε is a “good” function (i.e., it does not go to zero or infinity everywhere) and taking the change of variables ∂x→ε∂x′, the charge continuity equation for the spatial-temporal evolution of the potential Ψ can be written in terms of a permittivity scaled conductivity tensor ΣΣ={σᵢⱼ/ε} as

$$\frac{\partial }{\partial t} ( {∇}^{2} Ψ ) = - ∇ \cdot \sum \cdot ∇ Ψ + ℱ , \qquad ( 2 )$$

where we have included a possible external source (or forcing) term F. For brain fiber tissues, the conductivity tensor Σ might have significantly larger values along the fiber direction than across them. The charge continuity without forcing i.e., (F=0) can be written in tensor notation as

∂ₜ∂ᵢ²Ψ+Σᵢⱼ∂ᵢ∂ⱼΨ+(∂ᵢΣᵢⱼ)(∂ⱼΨ)=0, (3)

where repeating indices denote summation. Simple linear wave analysis, i.e., substitution of Ψ~exp(−i(k·r−Ωt)), where k is the wavenumber, r is the coordinate, Ω is the frequency and t is the time, gives the following complex dispersion relation:

D(Ω,k)=−iΩkᵢ²−Σᵢⱼkᵢkⱼ−i∂ᵢΣᵢⱼkⱼ=0, (4)

which is composed of the real and imaginary components:

$$\begin{matrix}γ = 𝔍Ω = {\sum }_{ij} \frac{{k}_{i} {k}_{j}}{{k}^{2}} & ω = 𝔄Ω = - \frac{{\partial }_{i} {\sum }_{ij} {k}_{j}}{{k}^{2}}\end{matrix} . \qquad ( 5 )$$

Although in this general form the electrostatic potential Ψ, as well as the dispersion relation D(Ω,k), describe three dimensional wave propagation, in anisotropic and inhomogeneous media, some directions of wave propagation are more equal than others with preferred directions determined by the complex interplay of the anisotropy tensor and the inhomogeneity gradient. While this is of significant practical importance, in particular because the anisotropy and inhomogeneity can be directly estimated from non-invasive methods, for the sake of clarity we focus here on the one-dimensional scalar expressions for spatial variables x and k that can be easily generalized for the multi-dimensional wave propagation as well.

Based on the nonlinear Hamiltonian formulation of the WETCOW theory, there exists an anharmonic wave mode

H^{s}(a,a^{†})=Γaa^{†}aa^{†}[βₐa+βₐ_{ⁱ}a^{†}−2α(aa^{†})^{1/2}] (6)

where a is a complex wave amplitude and a^{†} is its conjugate. The amplitude a denotes either temporal aₖ(t) or spatial a_{ω}(x) wave mode amplitudes that are related to the spatiotemporal wave field Ψ(x,t) through Fourier integral expansions:

$${a}_{k} ( t ) = \frac{1}{2 π} {\int }_{- ∞}^{∞} Ψ ( x , t ) {e}^{- i ( kx + {ω}_{k} t )} dx , \qquad ( 7 )$$

$${a}_{ω} ( x ) = \frac{1}{2 π} {\int }_{- ∞}^{∞} Ψ ( x , t ) {e}^{- i ( {k}_{ω} x + ωt )} dt , \qquad ( 8 )$$

where for the sake of clarity we use one dimensional scalar expression for spatial variables x and k, but it can be easily generalized for the multi-dimensional wave propagation as well. The frequency ω and the wave number k of the wave modes satisfy the dispersion relation D(ω,k)=0, and ωk and kω denote the frequency and the wave number roots of the dispersion relation (the structure of the dispersion relation and its connection to the brain tissue properties has been discussed by Galinsky and Frank, supra).

The first term Γaa^{†} in Equation (6) denotes the harmonic (quadratic) part of the Hamiltonian with either the complex valued frequency Γ=iω+γ or wave number Γ=ik+λ that both include pure oscillatory parts (ω or k) and possible weak excitation or damping rates, either temporal γ or spatial λ. The second anharmonic term is cubic in the lowest order of nonlinearity and describes the interactions between various propagating and non-propagating wave modes, where α, βₐ and βₐ^{†} are the complex valued strengths of those different nonlinear processes. This theory can be extended to a network of interacting wave modes of the form of Equation (6), which can be described by a network Hamiltonian form that describes discrete spectrum of those multiple wave modes as

$$H ( a , {a}^{†} ) = {\sum }_{n} [ {H}^{s} ( {a}_{n} , {a}_{n}^{†} ) + {\sum }_{m \neq n} ( {a}_{n} {r}_{nm} {a}_{m}^{†} + {a}_{n}^{†} {r}_{nm}^{*} {a}_{m} ) ] \qquad ( 9 )$$

where the single mode amplitude aₙ again denotes either aₖ or a_{ω}, aa≡{aₙ} and rₙₘ=wₙₘe_{iδnm}, is the complex network adjacency matrix with wₙₘ providing the coupling power and δₙₘ taking into account any possible differences in phase between network modes. This description includes both amplitude R(a) and phase I(a) mode coupling and allows for significantly unique synchronization behavior different from phase coupled Kuramoto oscillator networks and from networks of amplitude coupled integrate-and-fire neuronal units.

An equation for the nonlinear oscillatory amplitude a then can be expressed as a derivative of the Hamiltonian form

$$\frac{da}{dt} = \frac{\partial {H}^{s}}{\partial {a}^{†}} ≡ Γ a + {β}_{{a}^{†}} {aa}^{†} + {β}_{a} {a}^{2} - α {a ( {aa}^{†} )}^{1 / 2} , \qquad ( 10 )$$

after removing the constants with a substitution of β_{a†}=½β~a^{†} at and a=⅓ã and dropping the tilde. Note that although Equation (10) is for the temporal evolution, the spatial evolution of the mode amplitudes a_{ω}(x) can be described by a similar equation substituting temporal variables by their spatial counterparts, i.e., (t,ω,γ)→(x,k,λ).

Splitting Equation (10) into an amplitude/phase pair of equations using a=Ae_{iφ} and making some rearrangements these equations can be rewritten as

$$\frac{dA}{dτ} = γ A + {A}^{2} [ {w}^{a} cos ( ϕ - ψ ) - α ] , \qquad ( 11 )$$

$$\frac{dϕ}{dτ} = ω + {Aw}^{ϕ} cos ϕ , \qquad ( 12 )$$

where ψ, wₐ and w_{φ} are model constants.

### Single Mode Firing Rate

The effective period of spiking Tₛ (or its inverse—either the firing rate 1/Tₛ or the effective firing frequency ωₛ=2π/Tₛ) was estimated as

$${T}_{s} = \frac{2 π}{ω \sqrt{1 - {γ}^{2} / {γ}_{c}^{2}}} = \frac{2 π}{ω \sqrt{1 - {ω}_{c}^{2} / {ω}^{2}}} , \qquad ( 13 )$$

ωₛ=ω\sqrt{1−γ²/γ_{c}²}=\sqrt{ω²−ω_{c}²}, (14)

where the critical frequency ω_{c} or the critical growth rate γ_{c} can be expressed as

$${ω}_{c} = γ w , {γ}_{c} = \frac{ω}{w} , \qquad ( 15 )$$

where

$$w = \frac{{w}^{ϕ} cos {ϕ}^{c}}{α + {w}^{Ω} cos ( {ϕ}^{c} + ψ )} , \qquad ( 16 )$$

and

$${ϕ}^{c} = arctan [ \frac{{w}^{a} sin ψ}{\sqrt{{α}^{2} - {( {w}^{a} sin ψ )}^{2}}} ] . \qquad ( 17 )$$

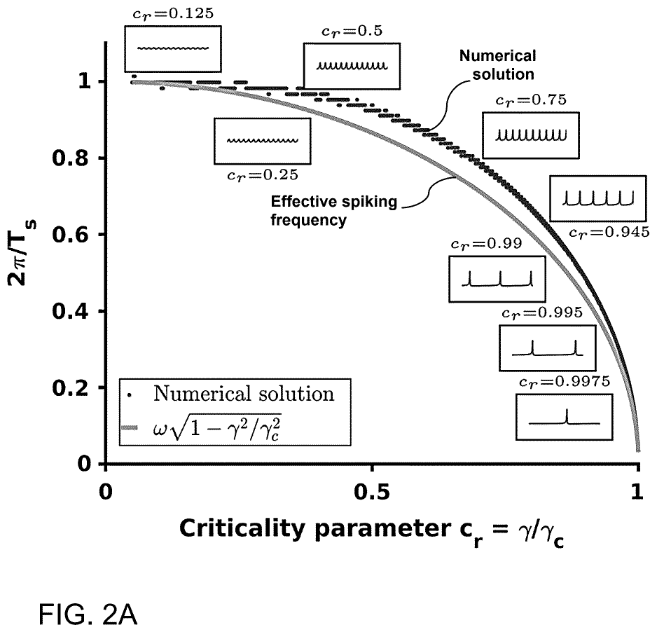

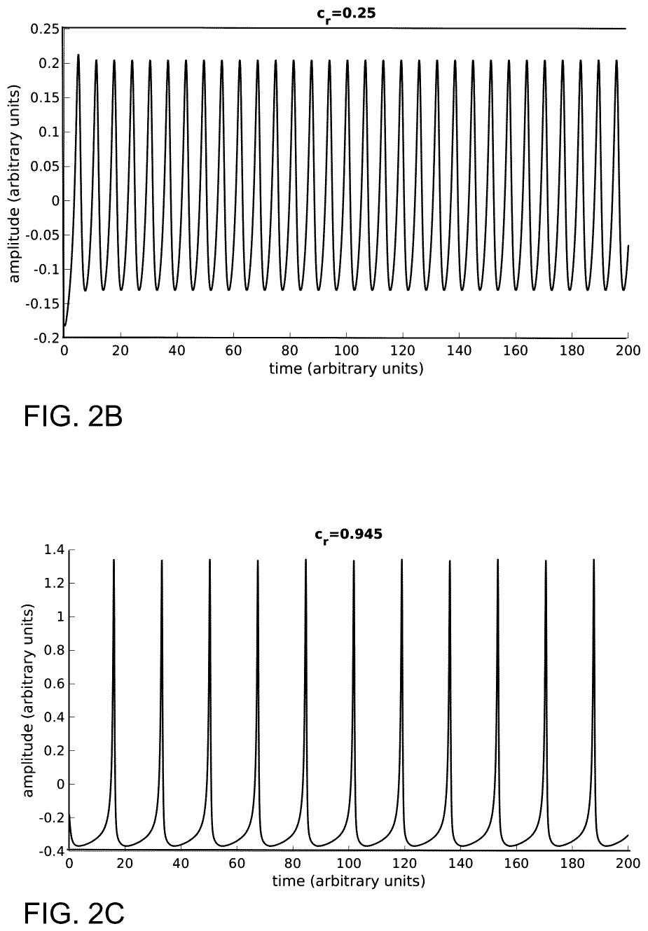

FIG. 2A compares the single mode results of Equations (13) to (15) with peak-to-peak period/frequency estimates from direct simulations of the system of Equations (11) and (12). The insets provide examples of shapes of the numerical solutions generated at the correspondent level of criticality cᵣ

$${c}_{r} = \frac{γ}{{γ}_{c}} = w \frac{γ}{ω} . \qquad ( 18 )$$

FIGS. 2B and 2C provide a few examples of detailed plots used to generate the different numerical solutions shown in FIG. 2A for the indicated values of the criticality parameters cᵣ=0.25 and 0.945, respectively.

The above analytically derived single mode results of Equations (13) to (15) can be used directly to estimate firing of interconnected networks as they express the rate of spiking as a function of a distance from criticality, and the criticality value can be in turn expressed through other system parameters.

A set of coupled equations for a network of multiple modes can be derived in an approach similar to the single mode Equations (11) and (12) by taking a derivative of the network Hamiltonian form of Equation (9) and appropriately changing variables. This gives for the amplitude Aᵢ and the phase φᵢ a set of coupled equations

$$\frac{{dA}_{i}}{dt} = {γ}_{i} {A}_{i} + {A}_{i}^{2} ( {w}_{i}^{a} cos ( {ϕ}_{i} - {ψ}_{i} ) - {α}_{i} ) + {\sum }_{j \neq i} {w}_{ij} {A}_{j} cos ( {ϕ}_{j} - {ϕ}_{i} - {δ}_{ij} ) , \qquad ( 19 )$$

$${A}_{i} \frac{d {ϕ}_{i}}{dt} = {ω}_{i} {A}_{i} + {A}_{i}^{2} {w}_{i}^{ϕ} cos {ϕ}_{i} + {\sum }_{j \neq i} {w}_{ij} {A}_{j} sin ( {ϕ}_{j} - {ϕ}_{i} - {δ}_{ij} ) . \qquad ( 20 )$$

In the small (and constant) amplitude limit (Aᵢ=const) this set of equations turns into a set of phase coupled harmonic oscillators with a familiar sin(φⱼ−φᵢ . . . ) form of phase coupling. However, in its general form, Equations (19) and (20) include also phase dependent coupling of amplitudes (cos(φⱼ−φᵢ . . . )), which dynamically defines whether the input from j to i will play either excitatory (|φⱼ−φᵢ+ . . . +|<π/2) or inhibitory (|φⱼ−φᵢ+ . . . |>π/2) roles (this is in addition to any phase shift introduced by the static network attributed phase delay factors δᵢⱼ).

### Synchronized Network Memory of a Single Mode Sensory Response

Starting with a single unconnected mode that is excited by a sensory input, based on the strength of excitation the mode can be in any of the states shown in FIG. 2, with activity ranging from small amplitude oscillations in a linear regime, to nonlinear anharmonic oscillations, to spiking with different rates (or effective frequencies) in sub-critical regime, to a single spike-like transition following by silence in supercritical range of excitation. The type of activity is determined by the criticality parameter cᵣ=(γ₀+γᵢ)/γ_{c} where γ_{c} depends on the parameters of the system of Equation (15) and γ₀ determines the level of sensory input and γᵢ is the level of background activation (either excitation or inhibition). Hence, for any arbitrary ith mode

$$\frac{{dA}_{i}}{dt} = ( {γ}_{0} + {γ}_{i} ) {A}_{i} + {A}_{i}^{2} ( {w}_{i}^{a} cos ( {ϕ}_{i} - {ψ}_{i} ) - {α}_{i} ) \qquad ( 21 )$$

$$\frac{{dϕ}_{i}}{dt} = {ω}_{i} + {A}_{i} {w}_{i}^{ϕ} cos {ϕ}_{i} . \qquad ( 22 )$$

As a result, the mode i will show nonlinear oscillation with an effective frequency ωₛ:

ωₛ=\sqrt{ωᵢ²−(γ₀+γᵢ)²ωᵢ²}, (23)

$${w}_{i} = \frac{{w}_{i}^{ϕ} cos {ϕ}_{i}^{c}}{{α}_{i} + {w}_{i}^{a} cos ( {ϕ}_{i}^{c} + {ψ}_{i} )} , \qquad ( 24 )$$

$${ϕ}_{i}^{ε} = arctan [ \frac{{w}_{i}^{a} sin {ψ}_{i}}{\sqrt{{α}_{i}^{2} - {( {w}_{i}^{a} sin {ψ}_{i} )}^{2}}} ] . \qquad ( 25 )$$

Next, assume that instead of a single mode there is a network of modes described by Equations (11) and (12) where the sensory excitation is absent (γ₀=0) and for simplicity first assume that all the parameters (γᵢ,ωᵢ,αᵢ,ψᵢ,wₐᵢ, and w_{φi}) are the same for all modes and only the coupling parameters wᵢⱼ and δᵢⱼ on can vary. The mean excitation level for the network γ₁≡γᵢ (i=1 . . . N) determines the type of activity at which the unconnected modes would be operating, which may be in any of the linear, nonlinear, sub-critical or supercritical range. The activity of individual modes in the network of Equations (11) and (12) depends on the details of coupling (parameters wᵢⱼ and δᵢⱼ) and can be very complex. Nevertheless, one of the features of the phase-amplitude coupled system of Equations (11) and (12) that distinguishes it both from networks of phase coupled Kuramoto oscillators and from networks of amplitude coupled integrate and fire neurons (or actually from any networks that are based on spike summation generated by neurons of Hodgkin-Huxley type or it's derivations), is that even for relatively weak coupling the synchronization of some modes in network of Equations (11) and (12) may happen in a very efficient manner. The conditions for coupling coefficients when this synchronized state is realized and every mode i of the network produce the same activity pattern as sensory excited single mode, but without any external excitation, can be expressed for every mode i as

$${\sum }_{j} {w}_{ij} cos ( {δ}_{ij} ) = {γ}_{0} , \qquad ( 26 )$$

$${\sum }_{j} {w}_{ij} sin ( {δ}_{ij} ) = 0. \qquad ( 27 )$$

This is a necessary (but not sufficient) condition showing that every recurrent path through the network, i.e., every brain wave loop that does not introduce nonzero phase delays, should generate the same level of amplitude excitation.

Even for this already oversimplified case of identical parameters, the currently agreed lines of research proceed with even more simplifications and either employ constant (small) amplitude phase synchronization approach (Kuramoto oscillators) assuming that all δᵢⱼ equal to −π/2 or π/2, or use amplitude coupling (Hodgkin-Huxley neuron and the like) with δᵢⱼ equal to 0 (excitatory) or π (inhibitory). Both cases are quite limited and do not provide a framework for the effectiveness, flexibility, adaptability, and robustness characteristic of human brain functioning. The phase coupling is only capable of generating very slow and inefficient synchronization. The amplitude coupling is even less efficient as it completely ignores the details of the phase of the incoming signal, thus is only able to produce sporadic and inconsistent population level synchronization.

Equations (26) and (27) are used as an idealized illustrative picture of critically synchronized memory state formation in phase-amplitude coupled network of Equations (11) and (12). In practice, in the brain the parameters of the network of Equations (11) and (12), including frequencies, excitations, and other parameters of a single mode Hamiltonian (Equation (6)), may be different between modes. But even in this case, the formation of critically synchronized state follows the same procedure described above, and requires that for all modes total inputs to the phase and the amplitude parts (ω̅ᵢ and \dot{γ}ᵢ) generate together the same effective frequency ωₛ satisfying the relation

$${ω}_{s} = \sqrt{{\overline{ω}}_{i}^{2} - {\overline{γ}}_{i}^{2} {w}_{i}^{2}} , \qquad ( 28 )$$

$$where$$

$${\overline{γ}}_{i} = {γ}_{i} + {\sum }_{j} {w}_{ij} cos ( {δ}_{ij} ) , \qquad ( 29 )$$

$${\overline{ω}}_{i} = {ω}_{i} + {\sum }_{j} {w}_{ij} sin ( {δ}_{ij} ) . \qquad ( 30 )$$

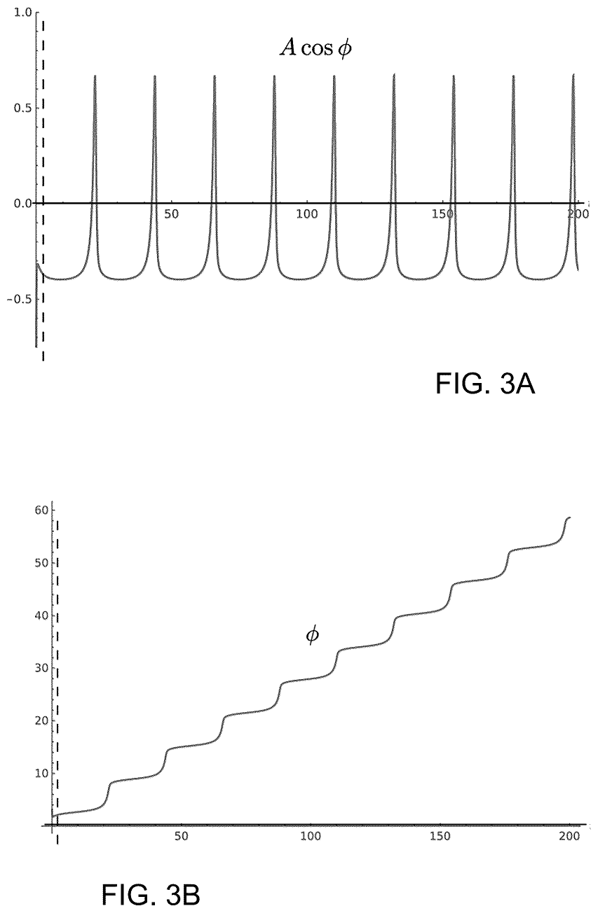

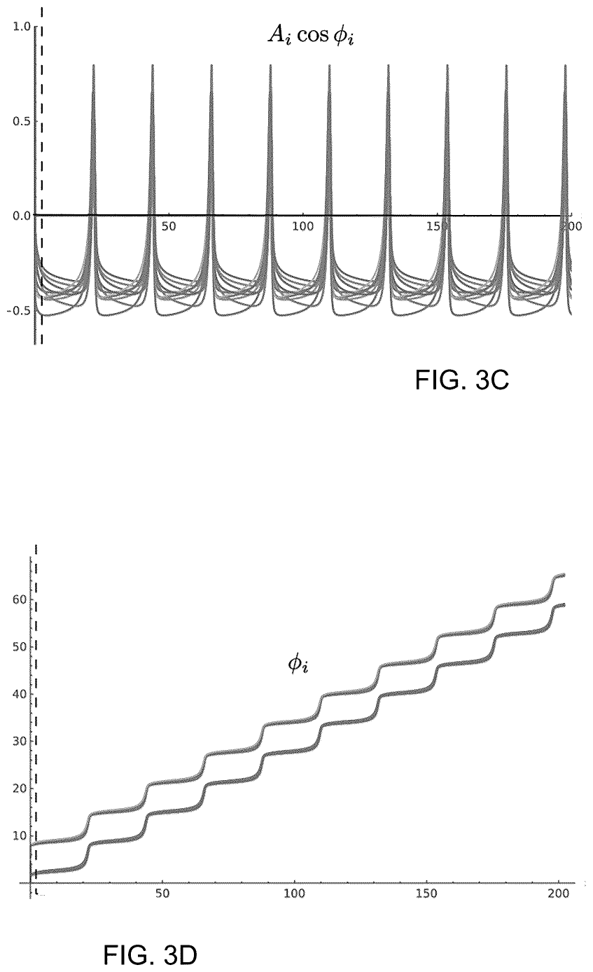

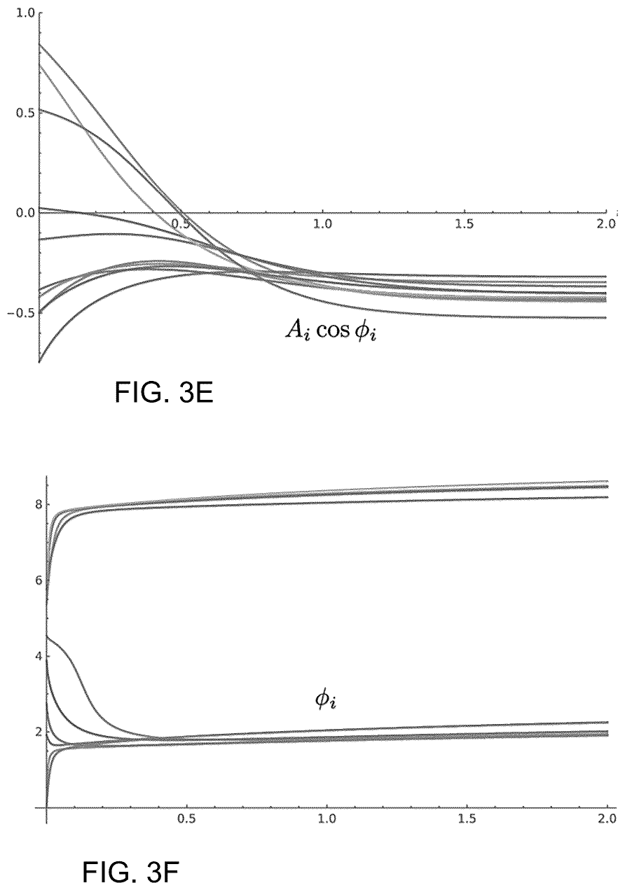

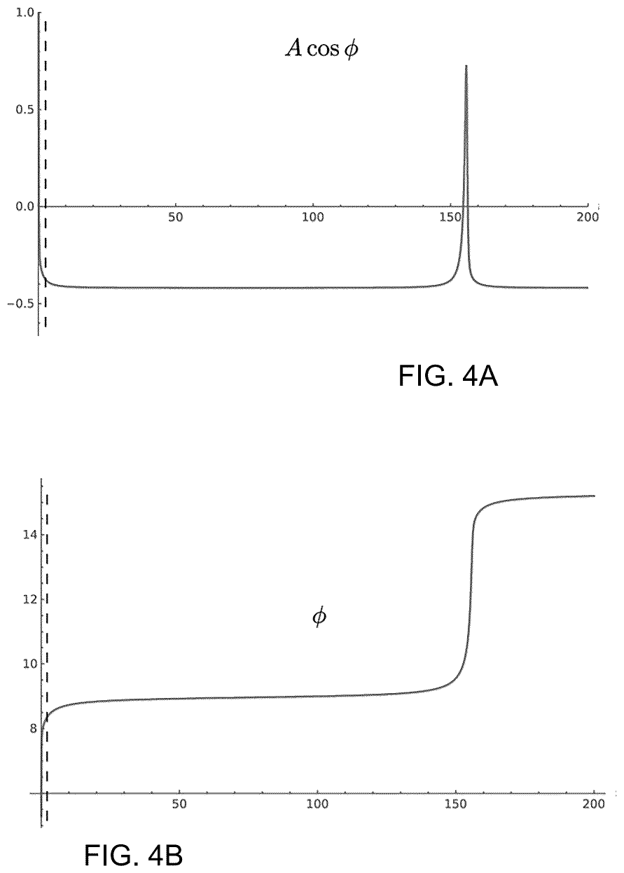

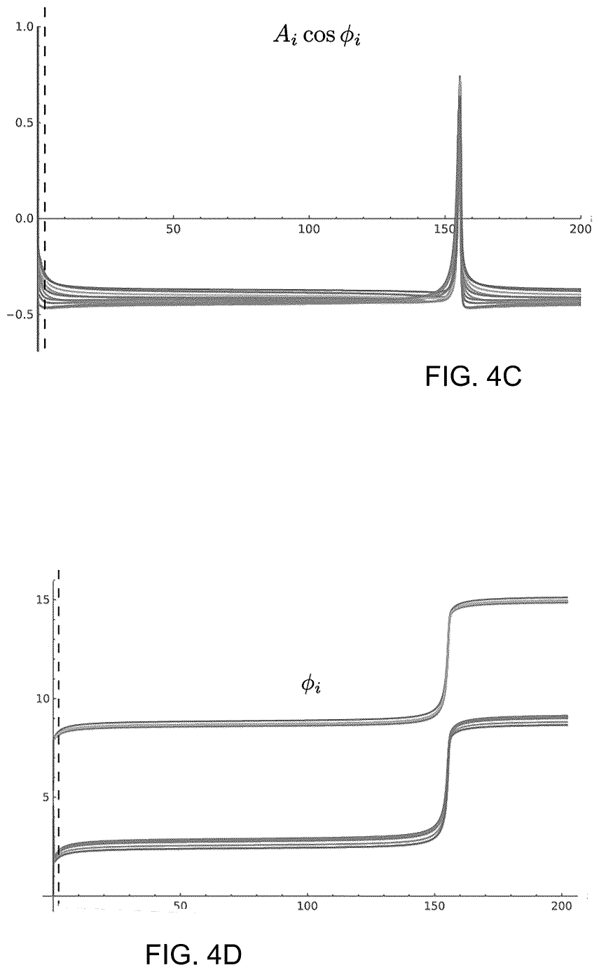

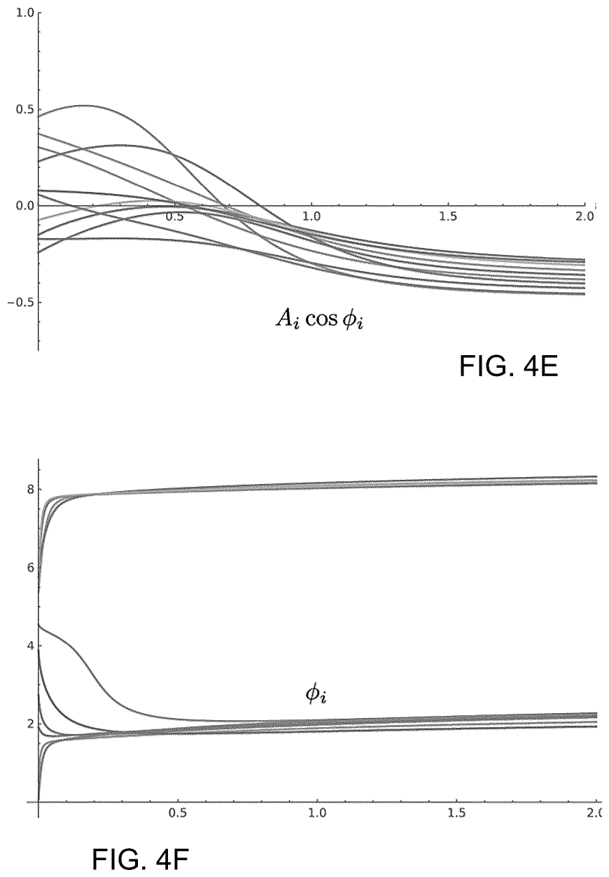

Overall, the critically synchronized memory can be formed by making a loop from as few as two modes. Of course, this may require an excessively large an amount of amplitude coupling and will not provide the flexibility and robustness of multimode coupling with smaller steps of adjustment of amplitude-phase coupling parameters. FIGS. 3A-3F and 4A-4F are amplitude and phase plots, respectively, providing examples of network synchronization with effective frequencies that replicate the original single mode effective frequency without sensory input. In each plot, the x-axis is time and the y-axis is amplitude, both in arbitrary units. FIGS. 3A-3B show a single mode subcritical spiking. FIGS. 3C-3D show the spiking of multiple modes with different linear frequencies co, critically synchronized at the same effective spiking frequency (the units are arbitrary). FIGS. 3E-3F respectively provide expanded views of wavefront shapes at initial parts of the amplitude and phase curves (corresponding to the dashed vertical lines in FIGS. 3A-3D), showing the difference for each mode, but indicating that the spiking synchronization between modes is strong and precise. These expanded views show the efficiency of synchronization, which occurs even faster than the single period of linear oscillations.

FIGS. 4A-4B are amplitude and phase plots, respectively, of a single mode spiking in a close to critical regime. FIGS. 4C-4D show the spiking of multiple modes with different linear frequencies ωᵢ critically synchronized at the same effective spiking frequency that is close to critical frequency (the units are arbitrary). Similar to subcritical spiking in FIGS. 3A-3F, the details of wavefront shapes for each mode are different, but the spiking synchronization between modes is very strong and precise. FIGS. 4E-4F provide expanded views of the initial part of the amplitude and phase of the mode shows the efficiency of synchronization. As can be seen in FIGS. 3E-3F and 4E-4F, ten modes were shown with the same parameters of

ωᵢ^{a}=ωᵢ^{φ}=\sqrt{5},ψᵢ=2 arctan(⅓),φᵢ^{c}=arctan(½),ωᵢ=½

but with a set of uniformly distributed frequencies ωᵢ, (with a mean of 1 and a standard deviation of 0.58-0.59). The network coupling ωᵢⱼ and δᵢⱼ were also selected from a range of values (from 0 to 0.2 for wᵢⱼ and −π/2 to π/2 for δᵢⱼ).

Again, for phase only coupling (δᵢⱼ equal to −π/2 or π/2) the synchronization is very inefficient and only happening as a result of an emergence of forced oscillations at common frequency in some parts of the network or in the whole network dependent on the details of the coupling parameters. The amplitude coupling of Hodgkin-Huxley and the like neurons is even less effective than phase-only coupling as it does not even consider the oscillatory and wave-like propagation nature of the subthreshold signals that contribute to the input and collective generation of spiking output. Therefore, expressions in Equations (28) to (30) are not applicable for HH and LIF models as phase information, as well as frequency dependence, is lost by those models and replaced by ad-hoc sets of thresholds and time constants.

Contrary to the lack of efficiency, flexibility, and robustness demonstrated by those state-of-the-art curtailed phase-only and amplitude-only approaches, the presented model of memory shows that when both phase and amplitude are operating together, a critical behavior emerging in the nonlinear system of Equation (9) gives rise to an efficient, flexible, and robust synchronization characteristic of human memory, appropriate for any type of coding, being it either rate or time.

### Application to Neural Networks and Machine Learning

The inventive critically synchronized memory model based on the concept of weakly evanescent brain waves—WETCOW has several important properties. First, the presence of both amplitude wᵢⱼ and phase βᵢⱼ coupling makes it possible to construct effective and accurate recurrent networks that do not require extensive and time-consuming training. The standard back propagation approach can be costly in terms of both computations, memory requirements, and large number of communications involved, therefore may be poorly suited to common hardware constraints in computers and neuromorphic devices. However, with the WETCOW-based model it is possible to construct a small shallow network that will replicate the spiking produced by any input condition using the interplay of the amplitude-phase coupling of Equations (19) to (20) and the explicit analytical conditions for spiking rate of Equations (13) and (15) as a function of criticality. The WiSNNs constructed using these analytical conditions provide highly accurate results with significantly reduced training and memory requirements when compared to standard neural networks.

The non-planarity of the critically synchronized WETCOW-inspired shallow neural network provides an additional approach to encode new knowledge with a different out-of-plane phase-amplitude choice, thus preserving previous accumulated knowledge. This makes the critically synchronized WETCOW-inspired shallow neural network model more suitable for the use in a continuous learning scenario.

Another important advantage of the WETCOW algorithms is their numerical stability, which makes them robust even in the face of extensive training. Because the system of Equations (19) and (20) describes the full range of dynamics, from linear oscillations to spiking in the perfectly differentiable form, it is perfectly differentiable. Thus, they are not subject to one of the major limitations of current standard models—the non-differentiability of the spiking nonlinearity for LIF (and similar) models, whose derivative is zero everywhere except at U=Θ, and even at U=Θ, the derivatives are not only large, but strictly speaking, they are not defined.

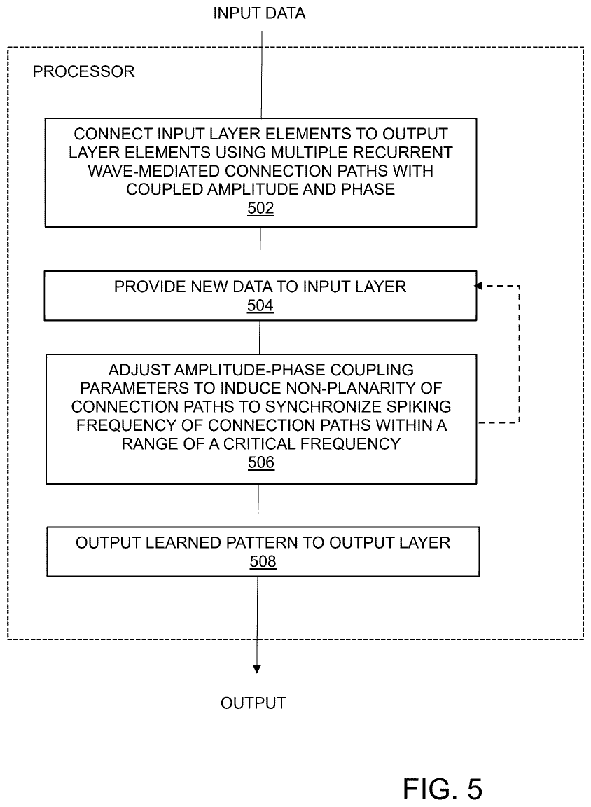

FIG. 5 provides a simple flow diagram of the key operations within a processor programmed to execute a WiSNN. In block 502, the WiSNN connects input layers consisting of input elements to an output layer using multiple recurrent wave-mediated connection paths in having both amplitude and phase coupled according to the coupling described by Equations (19) and (20). Input data serves as excitation for firing of the connection paths (block 504). As with standard neural networks, the input can be any form of data from which a pattern can be extracted, e.g., image data, alphanumerical data, signal data, or combinations thereof. The parameters of the amplitude-phase coupled wave modes are adjusted to control the non-planarity of the wave paths, allowing the spiking frequency of the connections to be synchronized within a range of a critical frequency (block 506). The critically synchronized connections generate spikes to generate outputs at output layer (block 508). The results of the operations are output by the processor, the results being the pattern learned from the input data. The dashed line between blocks 504 and 506 may correspond to a training process in which training data with known outcomes is entered in a supervised learning scenario prior to processing of “live” data with unknown outcomes, or it may represent an ongoing learning process through which the WiSNN expands its accumulated knowledge.

### MNIST Digits and MNIST Fashion Tests

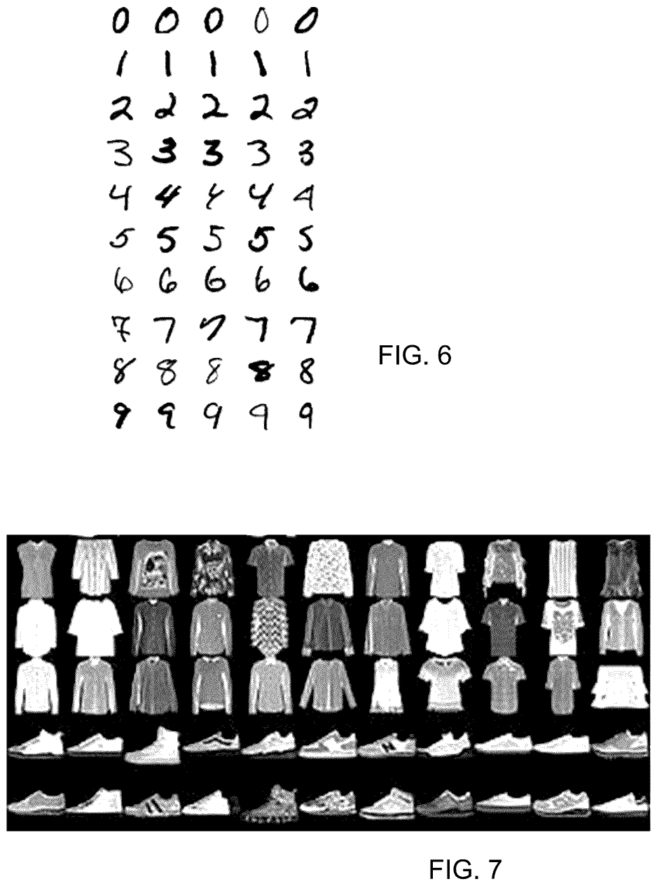

The performance and accuracy of WETCOW-based learning approaches has been demonstrated using two commonly used databases from the Modified National Institute of Standards and Technology database: MNIST and Fashion-MNIST. Both the original handwritten digits MNIST database (FIG. 6) and an MNIST-like fashion product database (FIG. 7), a set of Zalando's article images designed as a direct drop-in replacement for the original MNIST dataset, contain 60,000 training images and 10,000 testing images. Each individual image is a 28×28 pixel grayscale image, associated with a single label from 10 different labels. Specifically, for the digit dataset, the labels are the numbers “0” through “9”; for the fashion dataset, the labels are ten different fashion categories.

For the digit database, without training, the classification accuracy of the inventive algorithm was 0.9858-0.9883, or 117-142 errors per 10,000 samples. The total processing time was several seconds. With training, the digit database classification took several minutes and produced an accuracy of 0.9986, or 14 errors per 10,000 samples. By comparison, other classification algorithms yielded accuracies of from 0.88 to 0.998, with the higher accuracy results taking about 14 hours of computation time. For the Fashion MNIST data, without training, the inventive algorithm achieved an accuracy of 0.9385, equal to 615 errors per 10,000 samples with several seconds of processing. With training, the inventive algorithm achieved an accuracy of 0.9742, or 258 errors per 10,000 samples with processing times of several minutes. By comparison, other methods produced accuracies varying from 0.444 to 0.897 with processing times ranging from 1 to hours.

Results for the inventive WETCOW-based approach for a shallow recurrent neural network (SRNN) applied to the MNIST handwritten digits (FIG. 6) and MNIST fashion images (FIG. 7) are summarized in Table 1. In both cases, the networks were generated for 7×7 downsampled images moved and rescaled to the common reference system. For each dataset, Table 1 includes two rows for each dataset, the first row corresponding to an initial construction of a recurrent network that involves a single iteration, without back propagation and retraining steps, i.e., “without training. In both cases this initial step produces good initial accuracy, on par or even exceeding the final results of some of the deep ARCSes. The second row (“with training”) for each dataset lists the highest accuracy achieved and the corresponding training times. Comparing the third and fourth columns of Table 1, it is clear that, with or without training, WiSNNs are capable of generating results that are significantly more accurate than those obtained by deep ARCSes, in training times that are orders of magnitude faster.

TABLE 1

| | | | Deep ARCSe NNs |
|---|---|---|---|
| Data Source | SRNN Accuracy | Time | (accuracy/time) |
| MNIST-Digits | 0.9858-0.9883 | Several | |
| (Without training) | (117-142 errors | seconds | |
| | per 10000 samples) | | |
| MNIST-Digits | 0.9986 | Several | 0.88-0.998/14 |
| (With training) | (14 errors per | minutes | hours for 0.9977 |
| | 10000 samples) | | accuracy |
| MNIST-Fashion | 0.9385 | Several | |
| (Without training) | (615 errors per | seconds | |
| | 10000 samples) | | |
| MNIST-Fashion | 0.9742 | Several | 0.444-0.897/ |
| (With training) | (258 errors per | minutes | From 1 to 50 |
| | 10000 samples) | | hours |

The foregoing describes procedures and results derived from the physics-based theory of wave propagation in the cortex—the theory of weakly evanescent brain waves or “WETCOW”. WETCOW provides theoretical and computational frameworks to facilitate understanding of the adaptivity, flexibility, robustness, and effectiveness of human memory, which are instrumental in development of novel learning algorithms. The WETCOW-inspired shallow neural networks (WiSNNs) enable extreme data efficiency and adaptive resilience in dynamic environments, employing characteristic of biological organisms. Application of WiSNNs to classification of well-known image databases demonstrates excellent performance, providing results that are orders of magnitude faster than current state-of-the-art deep ARCSe methods and more accurate, exceeding the accuracy of current state-of-the-art deep ARCSe methods. Importantly, WiSNNs can be expected to be resistant to catastrophic forgetting, and capable of real-time sensing, learning, decision making, and prediction. Due to very efficient, fast, robust and precise spike synchronization, the WETCOW-inspired approach is highly effective in responding to novel, uncertain, and rapidly changing conditions in real-time, enabling well-informed decisions using small amounts of data over short time horizons. WiSNNs can include uncertainty quantification for data of high sparsity, large size, mixed modalities, and diverse distributions, and pushing the bounds on out-of-distribution generalization.

The inventive WETCOW-inspired shallow neural network approach surpasses existing neural networks through its emulation of biological-based learning using wave dynamic processes arising in neuroanatomical structures. WiSNNs achieve about twice the accuracy of existing AI/ML with over two orders of magnitudes (~500 times) improvement in speed.

The inventive approach can be extended to other types of networks, e.g., physical networks including cellular and radar networks, and can be applied to a wide range of applications such as communications and meteorology. The improved connectivity provided by the WiSNN model can be implemented using software, hardware, or a combination thereof. The multiple recurrent and redundant loop-like, non-planar connection paths employing amplitude weighting factors and a phase parameter to control non-planarity increase efficiency, reducing computational cost and memory demand. Other applications include use of the inventive approach for any of a broad range of problems involving artificial intelligence (AI), machine learning (ML), including diagnostics, e.g., medical image analysis, big data analysis, online commerce, digital surveillance and security, and agriculture. The WiSNN approach is expected to be particularly beneficial for AI applications, which tend to require massive amounts of computing time and, are therefore, are highly energy inefficient. Experts predict that the growth of AI will strain energy resources worldwide while contributing significant amounts of greenhouse gases. The efficiency of the WiSNN model in solving large AI problems allows low power AI devices to be developed, providing an environmentally responsible solution to the rapidly growing demand for AI.

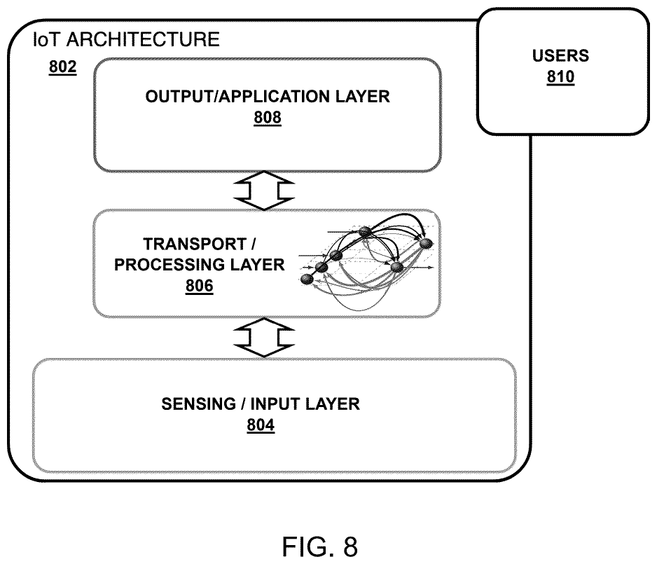

An exemplary application of the inventive WETCOW-inspired shallow network model is a communications network, a particular example of which is an internet of things (IoT) network as shown in FIG. 8, where the WiSSN serves as the middle layer in a three-layer IoT architecture 802. IoT networks interconnect potentially millions of things for purposes of distribution and management of communications and transactions. The input layer 804 includes the broad category of “sensors”—a wide range of detectors (electrical, mechanical, chemical, temperature, etc.), instrumentation, user interface devices (computers, data entry devices, mobile devices, etc.), industrial machinery and equipment, infrastructure monitors, cameras and image detectors, communications devices, and much more. These sensors collect and provide input data in various forms to input nodes of the network for distribution and processing via middle network layer 806, which corresponds to the shallow critically synchronized wave paths of the WiSSN. Use of the WiSSN approach significantly improves the efficiency of the handling and communication of the processed input data to the output application layer 808 where data may be further processed by servers for taking action, e.g., managing business transactions such as placing orders for goods or services, and/or the data processing results are communicated to databases for storage and/or further analysis. For example, a business transaction may trigger entry onto an inventory manifest along with initiating shipping of item(s) that are indicated by input data to be needed. Users 810 may connect to the system over the cloud for various actions such as initiating inputs via a user interface to sensing layer 804 or receiving output data or triggering an application or communication at a user interface via output layer 808. This sample application integrates the benefits of AI with IoT, first, by enhancing the IoT control loop, making it more efficient in terms of connectivity between the sensing/input layer and the output/application layer, and second, by reducing the computational expense of the AI operations through the use of WETCOW's shallow critically synchronized wave path neural network instead of the multiple hidden layers of conventional neural networks while providing the efficient processing required for decision making and automation within IoT networks. Based on the foregoing examples, other applications of the inventive WiSSN model to networks employing AI and ML operations will be readily apparent to those of skill in the art.

The various operations and processes described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product.

In a hardware implementation, the machine-readable media may be part of the processing system separate from the processor. However, as those skilled in the art will readily appreciate, the machine-readable media, or any portion thereof, may be external to the processing system. Alternatively, or in addition, the machine-readable media, or any portion thereof, may be integrated into the processor, e.g., via cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

Machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer.

Certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage media, including the previously described examples.

The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A neural network for machine learning, the network comprising:
an input layer comprising input elements configured for inputting data for processing;
an output layer comprising one or more output elements; and
a plurality of wave modes connecting the input elements to the one or more output elements, each wave mode comprising a recurrent path having an amplitude, a linear frequency, and a phase parameter, wherein the phase parameter is configured to control non-planarity of each wave mode so that amplitude and phase of the plurality of wave modes are coupled and spiking of the plurality of wave modes is synchronized at a same effective spiking frequency that is within a range of a critical frequency.

2. The neural network of claim 1, wherein data for processing comprises training data having known outcomes.

3. The neural network of claim 1, wherein the amplitude and phase are coupled according to the relationships:
$$\frac{{dA}_{i}}{dt} = {γ}_{i} {A}_{i} + {A}_{i}^{2} ( {w}_{i}^{a} cos ( {ϕ}_{i} - {ψ}_{i} ) - {α}_{i} ) + {\sum }_{j \neq i} {w}_{ij} {A}_{j} cos ( {ϕ}_{j} - {ϕ}_{i} - {δ}_{ij} )$$
and
$${A}_{i} \frac{d {ϕ}_{i}}{dt} = {ω}_{i} {A}_{i} + {A}_{i}^{2} {w}_{i}^{ϕ} cos {ϕ}_{i} + {\sum }_{j \neq i} {w}_{ij} {A}_{j} sin ( {ϕ}_{j} - {ϕ}_{i} - {δ}_{ij} ) ,$$
where Ai is the amplitude, φ is the phase, ω is the wave mode frequency, and δ is static network attributed phase delay factors.

4. The neural network of claim 1, wherein the critical frequency is ω_{c}=γω, where
$$w = \frac{{w}^{ϕ} cos {ϕ}^{c}}{α + {w}^{a} cos ( {ϕ}^{c} + ψ )} , {ϕ}^{c} = arctan [ \frac{{w}^{a} sin ψ}{\sqrt{{α}^{2} - {( {w}^{a} sin ψ )}^{2}}} ] ,$$
and γ is a growth or damping rate.

5. The neural network of claim 1, wherein the input layer is configured for receiving sensor data in a communications network.

6. The neural network of claim 5, wherein the output layer is configured for generating output signals to an application layer in the communications network.

7. The neural network of claim 5, wherein the communications network is an Internet of Things (IoT) network.

8. A neural network apparatus comprising:
a processor configured to generate a neural network comprising:
an input layer having input elements configured for inputting data;
an output layer comprising one or more output elements; and
a plurality of wave modes connecting the input elements to the one or more output elements, each wave mode comprising a recurrent path having an amplitude, a linear frequency, and a phase parameter, wherein the phase parameter is configured to control a shape and planarity of each wave mode so that amplitude and phase of the plurality of wave modes are coupled and spiking of the plurality of wave modes is synchronized at a same effective spiking frequency that within a range of a critical frequency.

9. The neural network apparatus of claim 8, wherein the amplitude and phase are coupled according to the relationships:
$$\frac{{dA}_{i}}{dt} = {γ}_{i} {A}_{i} + {A}_{i}^{2} ( {w}_{i}^{a} cos ( {ϕ}_{i} - {ψ}_{i} ) - {α}_{i} ) + {\sum }_{j \neq i} {w}_{ij} {A}_{j} cos ( {ϕ}_{j} - {ϕ}_{i} - {δ}_{ij} )$$
and
$${A}_{i} \frac{d {ϕ}_{i}}{dt} = {ω}_{i} {A}_{i} + {A}_{i}^{2} {w}_{i}^{ϕ} cos {ϕ}_{i} + {\sum }_{j \neq i} {w}_{ij} {A}_{j} sin ( {ϕ}_{j} - {ϕ}_{i} - {δ}_{ij} ) ,$$
where Ai is the amplitude, φ is the phase, ω is the wave mode frequency, and δ is static network attributed phase delay factors.

10. The neural network apparatus of claim 8, wherein the critical frequency is ω_{c}=γω, where
$$w = \frac{{w}^{ϕ} cos {ϕ}^{c}}{α + {w}^{a} cos ( {ϕ}^{c} + ψ )} , {ϕ}^{c} = arctan [ \frac{{w}^{a} sin ψ}{\sqrt{{α}^{2} - {( {w}^{a} sin ψ )}^{2}}} ] ,$$
and γ is a growth or damping rate.

11. The neural network apparatus of claim 8, wherein the input layer is configured for receiving sensor data in a communications network.

12. The neural network apparatus of claim 11, wherein the output layer is configured for generating output signals to an application layer in the communications network.

13. The neural network apparatus of claim 11, wherein the communications network is an Internet of Things (IoT) network.

14. A processor implemented learning method, comprising:
generating within a processor a neural network by connecting input elements of an input layer to one or more output elements of an output layer using a plurality of wave, each wave mode comprising a recurrent path having an amplitude, a linear frequency, and a phase parameter, wherein amplitude and phase of the plurality of wave modes are coupled and the phase parameter is configured to control non-planarity of each wave mode; and
applying input data to the input elements and adjusting the amplitude and phase parameter of each wave mode to synchronize spiking of the plurality of wave modes at a same effective spiking frequency that is within a range of a critical frequency.

15. The method of claim 14, wherein the amplitude and phase are coupled according to the relationships:
$$\frac{{dA}_{i}}{dt} = {γ}_{i} {A}_{i} + {A}_{i}^{2} ( {w}_{i}^{a} cos ( {ϕ}_{i} - {ψ}_{i} ) - {α}_{i} ) + {\sum }_{j \neq i} {w}_{ij} {A}_{j} cos ( {ϕ}_{j} - {ϕ}_{i} - {δ}_{ij} )$$
and
$${A}_{i} \frac{d {ϕ}_{i}}{dt} = {ω}_{i} {A}_{i} + {A}_{i}^{2} {w}_{i}^{ϕ} cos {ϕ}_{i} + {\sum }_{j \neq i} {w}_{ij} {A}_{j} sin ( {ϕ}_{j} - {ϕ}_{i} - {δ}_{ij} ) ,$$
where Ai is the amplitude, φ is the phase, ω is the wave mode frequency, and δ is static network attributed phase delay factors.

16. The method of claim 14, wherein the critical frequency is ω_{c}=γω, where
$$w = \frac{{w}^{ϕ} cos {ϕ}^{c}}{α + {w}^{a} cos ( {ϕ}^{c} + ψ )} , {ϕ}^{c} = arctan [ \frac{{w}^{a} sin ψ}{\sqrt{{α}^{2} - {( {w}^{a} sin ψ )}^{2}}} ] ,$$
and γ is a growth or damping rate.

17. The method of claim 14, wherein the input layer is configured for receiving sensor data in a communications network.

18. The method of claim 17, wherein the output layer is configured for generating output signals to an application layer in the communications network.

19. The method of claim 17, wherein the communications network is an Internet of Things (IoT) network.
